(19) United States
(12) Patent Application Publication
(10) Pub. No.: US 2011/0146466 A1
(43) Pub. Date: Jun. 23, 2011

(54) APPARATUS AND METHOD FOR CUTTING AND PUNCHING PRODUCTS

(75) Inventors: Wolfgang Matthes, Wurzen/OT Sachsendorf (DE); Klaus Schumann, Leipzig (DE); Roger Sonntag, Leipzig (DE)

(73) Assignee: HEIDELBERGER DRUCKMASCHINEN AKTIENGESELLSCHAFT, Heidelberg (DE)

(21) Appl. No.: 12/971,838

(22) Filed: Dec. 17, 2010

(30) Foreign Application Priority Data
Dec. 17, 2009 (DE) DE 102009058590.7
Jun. 23, 2010 (DE) DE 102010024771.5

(51) Int. Cl. B26D 9/00; B26D 1/09

(52) U.S. Cl. 83/52; 83/523

(57) ABSTRACT

An apparatus for the simultaneous three-sided trimming of products includes first and second cutting stations and a third processing station in which perforating or shaping punching operations can be carried out on the product at the same time as edge trimming in the preceding stations. A method for the final processing of bound or stitched products made from paper sheets is also provided.

### CROSS-REFERENCE TO RELATED APPLICATION

This application claims the priority, under 35 U.S.C. §119, of German Patent Applications DE 10 2009 058 590.7, filed Dec. 17, 2009 and DE 10 2010 024 771.5, filed Jun. 23, 2010; the prior applications are herewith incorporated by reference in their entirety.

### BACKGROUND OF THE INVENTION

### FIELD OF THE INVENTION

The invention relates to an apparatus for the simultaneous, three-sided trimming of products in a plurality of cutting stations, including a common top knife bridge which can be operated in a reciprocating movement, and at least knives to be attached to the top knife bridge for head trimming, foot trimming and front edge trimming of the products. The apparatus has at least one first cutting station for front edge trimming and one second cutting station for head and foot trimming and the apparatus has a transport device which transports the products into the individual stations of the apparatus and out of them again. The invention also relates to a method for the final processing of bound or stitched products made from paper sheets.

In the production of brochures, collated and stitched products are cut on gathering and stitching machines in an apparatus for three-sided trimming, for instance a trimmer. That takes place in the cutting stations for front trimming and head and foot trimming with a top knife moving against a fixed bottom knife.

In that case, the three-sided trimming is carried out in individual steps. The front trimming takes place in a first cutting station during a standstill of the transport system. The product is then conveyed by the transport system into a second cutting station. There, the head and foot trimming likewise takes place during a standstill of the transport system. Finally, the product which has been trimmed on three sides is transported into a delivery device. A trimmer of that type is known from European Patent Application EP 1 152 310 A1, corresponding to U.S. Patent Application Publication No. US 2001/0037708 A1.

Furthermore, Swiss Patent CH 561 593, corresponding to U.S. Pat. No. 3,811,350, has disclosed an apparatus for cutting a stack of sheets to size. In that apparatus, there is additionally a further knife for dividing double copies in the second station.

Should the products, furthermore, be given special punching operations, such as perforating punching operations, register punching operations or perforations, the products subsequently have to be fed to a special machine for those special punching operations.

### SUMMARY OF THE INVENTION

It is accordingly an object of the invention to provide an apparatus and a method for cutting and punching products, which overcome the hereinafore-mentioned disadvantages of the heretofore-known apparatuses and methods of this general type and in which, in addition to edge trimming and/or division of double copies, special punching operations can be carried out at the same time.

With the foregoing and other objects in view there is provided, in accordance with the invention, an apparatus for the simultaneous, three-sided trimming of products. The apparatus comprises a common top knife bridge to be operated in a reciprocating movement, at least one first cutting station having knives to be attached to the top knife bridge for front edge trimming of the products, at least one second cutting station having knives to be attached to the top knife bridge for head trimming and foot trimming of the products, a third station having special punching dies for performing special punching operations on the products, and a transport device for transporting the products into and out of the individual stations.

With the objects of the invention in view, there is also provided a method for the final processing of bound or stitched products made from paper sheets. The method comprises simultaneously performing at least one of front edge trimming, head and foot trimming or cuts for dividing double copies as well as special punching operations on the products in different stations with a reciprocating movement of a common top knife bridge.

Therefore, in one preferred embodiment, the apparatus for the simultaneous three-sided trimming of products has a common top knife bridge which can be operated in a reciprocating movement. The top knife bridge extends through three processing stations. The knives for head trimming, foot trimming and front edge trimming of the products are attached to the top knife bridge, as well as special punching dies, through the use of which special punching operations are performed in the third processing station. A transport apparatus transports the products into the individual stations of the apparatus and out of them again.

Through the use of the invention, a combination of edge trimming, dividing of double copies, introducing perforating punching operations and other shaping punching operations is possible at the same time in the three stations with a reciprocating movement of the top knife bridge.

In accordance with a concomitant feature of the invention, a knife for copy dividing is additionally fastened to the top knife bridge, at least in the second cutting station.

The advantage of the trimmer according to the invention with three processing stations, therefore includes the broadening of the product spectrum which can be processed as a result of the option of carrying out punching cuts with single dividing knives (independently of the product thickness with a simultaneously higher cut quality), and of carrying out the combination of dividing cuts and punching operations in one pass with a simultaneous reduction of the formats in the case of double copies.

Other features which are considered as characteristic for the invention are set forth in the appended claims.

Although the invention is illustrated and described herein as embodied in an apparatus and a method for cutting and punching products, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

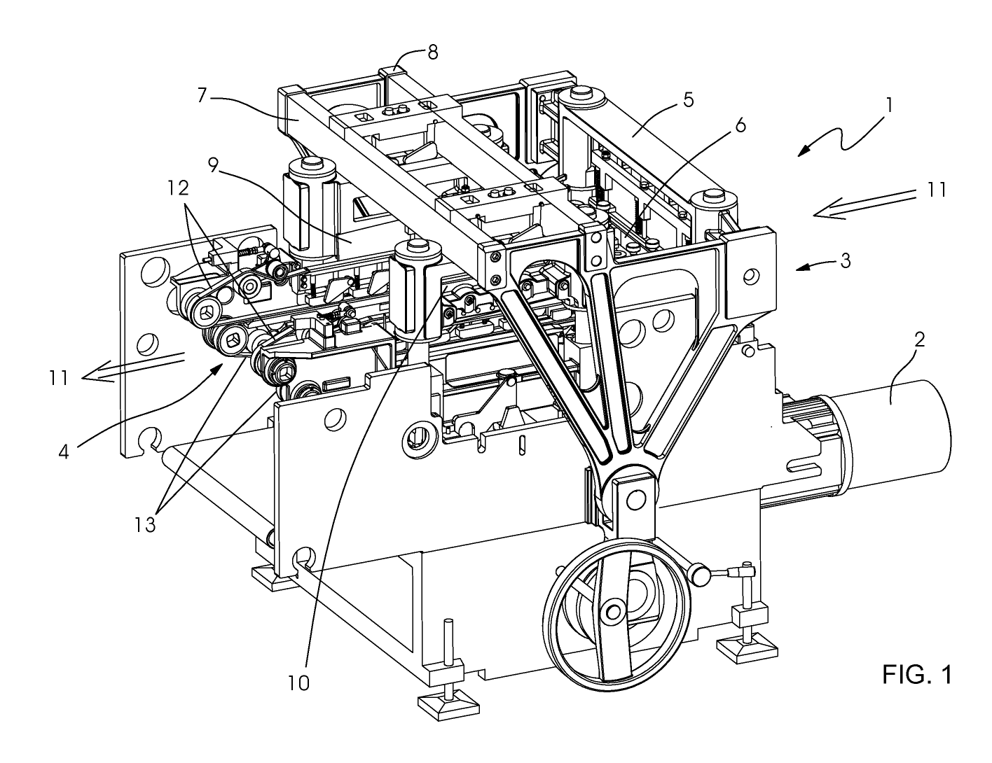

FIG. 1 is a diagrammatic, perspective view of a trimmer for conventional two step operation;

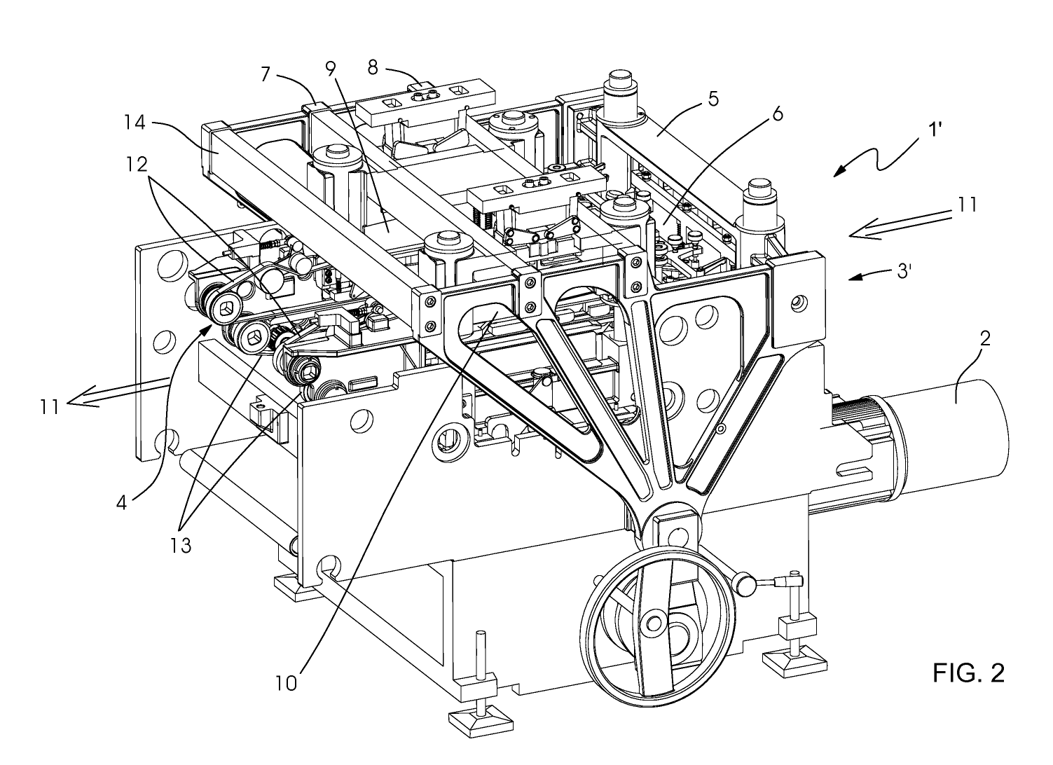

FIG. 2 is a perspective view of a trimmer according to the invention for three step operation;

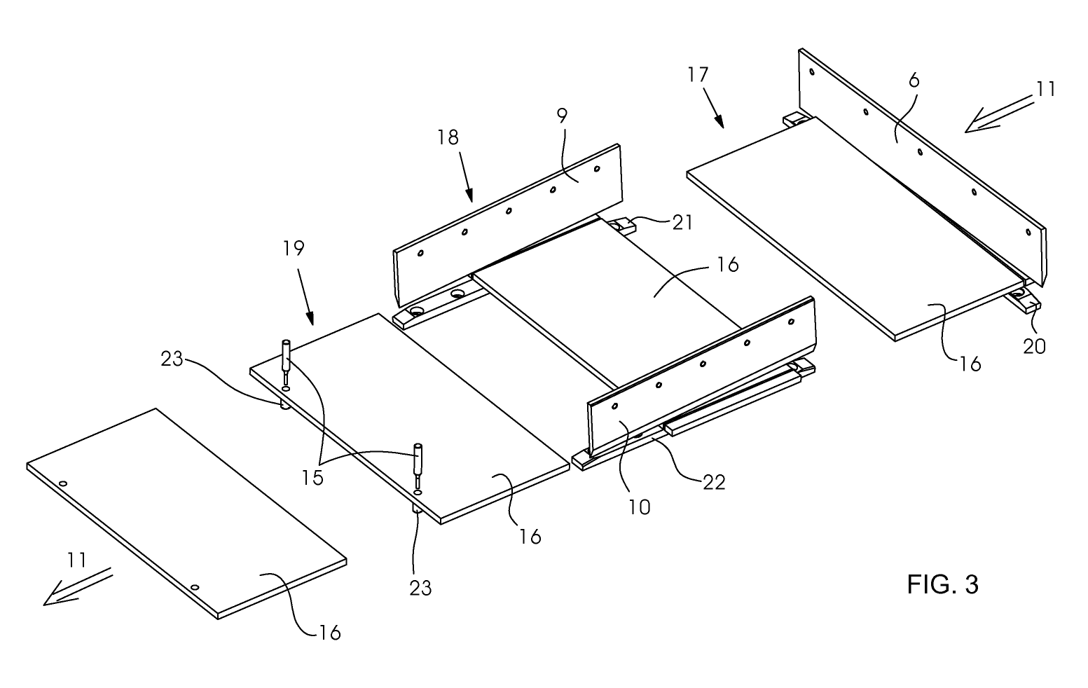

FIG. 3 is an exploded, perspective view showing the processing of a single copy with perforation in the third station;

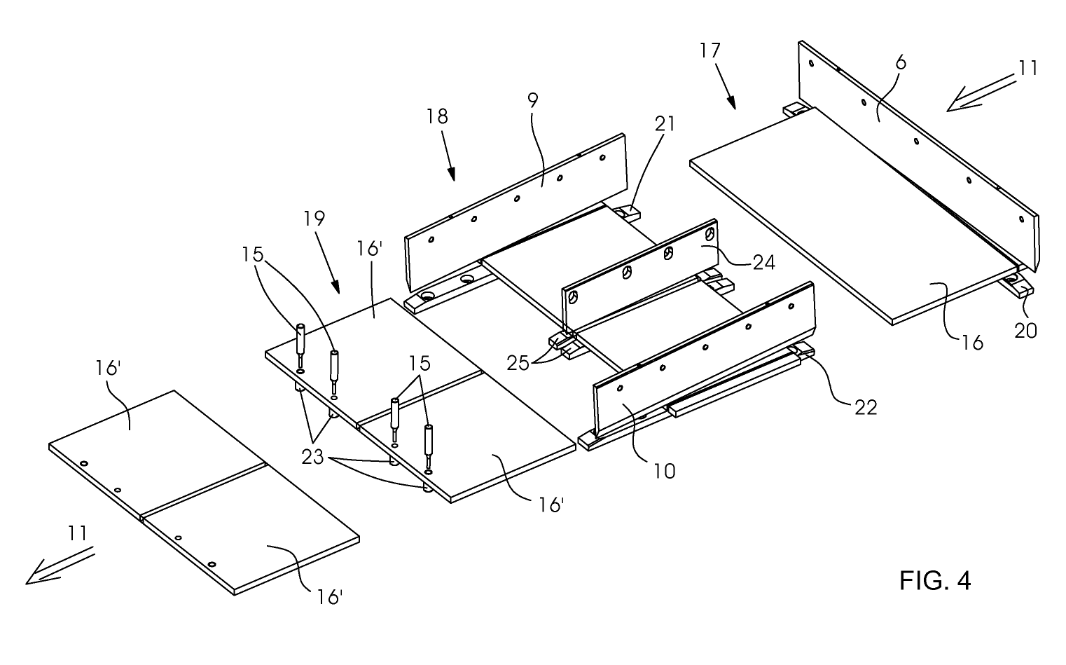

FIG. 4 is an exploded, perspective view showing the processing of a double copy with a punching cut in the second station and double perforation of each copy in the third station; and

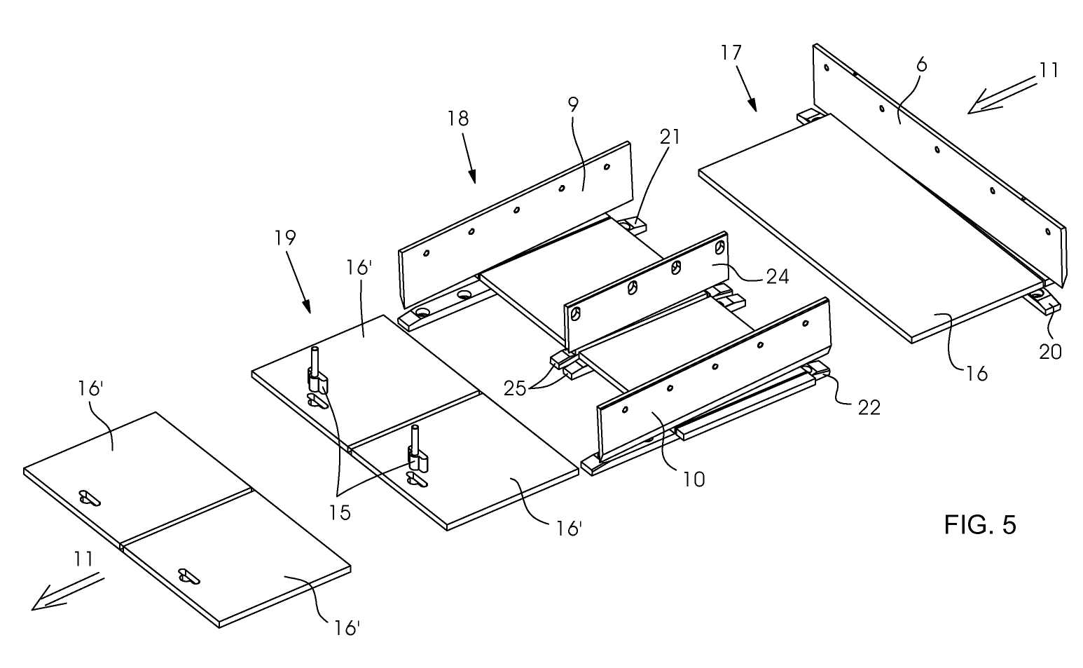

FIG. 5 is an exploded, perspective view showing the processing of a double copy with a punching cut in the second station and a standard European hole perforation of each copy in the third station.

### DETAILED DESCRIPTION OF THE INVENTION

Referring now to the figures of the drawings in detail and first, particularly, to FIG. 1 thereof, there is seen one representative example of a trimmer 1 for a conventional two cut operation. The trimmer has separate drive apparatuses for a top knife bridge 3 and for a transport system 4, of which only a drive motor 2 is shown in FIG. 1. This drive motor 2 realizes a movement of the top knife bridge 3, to which top knives 6, 9, 10 are fastened. The top knife 6 for front edge trimming in a first station is fastened to a front part 5 of the top knife bridge 3, and the top knives 9, 10 for foot and head trimming in a second station are fastened to a rear part 7, 8 of the top knife bridge 3. A knife 24 (see FIGS. 4 and 5) for dividing double copies can also additionally be fastened to the parts 7, 8 of the top knife bridge 3. A product running direction is labeled by arrows 11. A non-illustrated drive motor drives upper transport belts 12 and lower transport belts 13 of the transport system 4 for product transport through the individual stations.

FIG. 2 shows a trimmer 1′ according to the invention for three step operation. The trimmer 1′ corresponds substantially to the above-described construction of the trimmer 1 with the difference that a top knife bridge 3′ of the trimmer 1′ has a further part 14 for special perforating or punching dies 15 for processing products 16, 16′ in a third station.

For the sake of improved clarity, only components which are important for the processing of the products 16, 16′ are shown in the following FIGS. 3 to 5.

FIG. 3 diagrammatically shows the processing of a product 16 in three processing stations 17, 18, 19. Front edge trimming of the product 16 takes place through the use of the top knife 6 and a bottom knife 20 in the first cutting station 17. The product 16 is at a standstill during the trimming. Subsequently, the product 16 is transported through the use of the transport system 4 into the second cutting station 18 for head and foot trimming. Head trimming takes place through the use of the top knife 10 and a bottom knife 22, and foot trimming takes place through the use of the top knife 9 and a bottom knife 21. The head and foot trimming also take place when the product 16 is at a standstill. The product 16 is subsequently transported into the third processing station 19 through the use of the transport system 4. In the present exemplary embodiment, double perforation punching takes place in this processing station 19 through the use of two perforating dies 15 and two piercing die bushes 23 for the perforation punching operations. The finished processed product 16 is subsequently transported out of the trimmer.

FIG. 4 diagrammatically shows an alternative processing operation of a product 16 in the three processing stations 17, 18, 19. The front edge trimming of the product 16 takes place when the product is at a standstill through the use of the top knife 6 and the bottom knife 20 in the first cutting station 17. After the transport of the product 16 into the second cutting station 18, the foot and head trimming of the product 16 takes place when the product is at a standstill through the use of the top knives 9, 10 and the corresponding bottom knives 21, 22. At the same time, the dividing of the product 16 into double copies 16′ additionally takes place through the use of the top knife 24 against bottom knives 25. The top knife 24 is configured as a punching knife with a V-shaped punching profile. The two double copies 16′ are subsequently transported into the third processing station 19. In this case, one double perforation punching operation into each respective one of the double copies 16′ once again takes place when the product is at a standstill through the use of four perforating dies 15 and associated piercing die bushes 23. As an alternative, it is also possible to carry out only a single dividing cut by way of a single dividing knife 24 and a bottom knife 25 in the second cutting station 18 and thus to produce only one double copy 16′ in the second cutting station 18 and to carry out a second dividing cut for the second double copy 16′ in the third processing station 19 by way of a second single dividing knife 24 and a bottom knife 25, optionally at the same time as the double perforating punching operations for each double copy 16′. The finished processed double copies 16′ are transported out of the trimmer.

FIG. 5 diagrammatically shows a further alternative processing operation of a product 16 in three processing stations 17, 18, 19. In contrast to the processing operation according to FIG. 4, each double copy 16′ is provided centrally with a so-called standard European punched slot in the third processing station 19 in the variant according to FIG. 5.

The exemplary embodiments which are shown merely represent, by way of example, the different types of perforating and punching operations which can be listed at this point due to their variety in a non-concluding manner, and do not represent a restriction of the invention to the exemplary embodiments.

1. An apparatus for the simultaneous, three-sided trimming of products, the apparatus comprising:
a common top knife bridge to be operated in a reciprocating movement;
at least one first cutting station having knives to be attached to said top knife bridge for front edge trimming of the products;
at least one second cutting station having knives to be attached to said top knife bridge for head trimming and foot trimming of the products;
a third station having special punching dies for performing special punching operations on the products; and
a transport device for transporting the products into and out of said stations.

2. The apparatus according to claim 1, wherein said punching dies are fastened to said top knife bridge.

3. The apparatus according to claim 1, which further comprises knives fastened to said top knife bridge at least in said second cutting station, for copy dividing.

4. A method for the final processing of bound or stitched products made from paper sheets, the method comprising the following steps:
simultaneously performing at least one of front edge trimming, head and foot trimming or cuts for dividing double copies as well as special punching operations on the products in different stations with a reciprocating movement of a common top knife bridge.
